(19) United States
(12) Patent Application Publication
(10) Pub. No.: US 2009/0238544 A1
(43) Pub. Date: Sep. 24, 2009

(54) Video greeting card

(76) Inventor: Frank C. Orsini, Hoboken, NJ (US)

Correspondence Address: FRANK C. ORSINI, 103 4th St. #2, Hoboken, NJ, 07030, US

(21) Appl. No.: 12/076,985

(22) Filed: Mar. 24, 2008

(51) Int. Cl. H04N 7/26

(52) U.S. Cl. 386/124; 40/124.03

(57) ABSTRACT

The Video Greeting Card is a Greeting Card/Invitation that has a video/multi media monitor/player and screen attached into the card. Whether it's a birthday, holiday, seasonal, anniversary, humor, wedding invitation, business card or any type of card—upon receiving the greeting card, a video is ready to play and replay. An example would be when sending a “Birthday Card”, instead of just the words and message, the card will have a video which will play a video wishing the receiver a Happy Birthday. The video imagine sent can be a personal video that conveys your intentions in a truly personal manner or even down loaded from the internet. Imagine instead of sending/receiving the “Family Christmas Letter”, you can send it in video form.

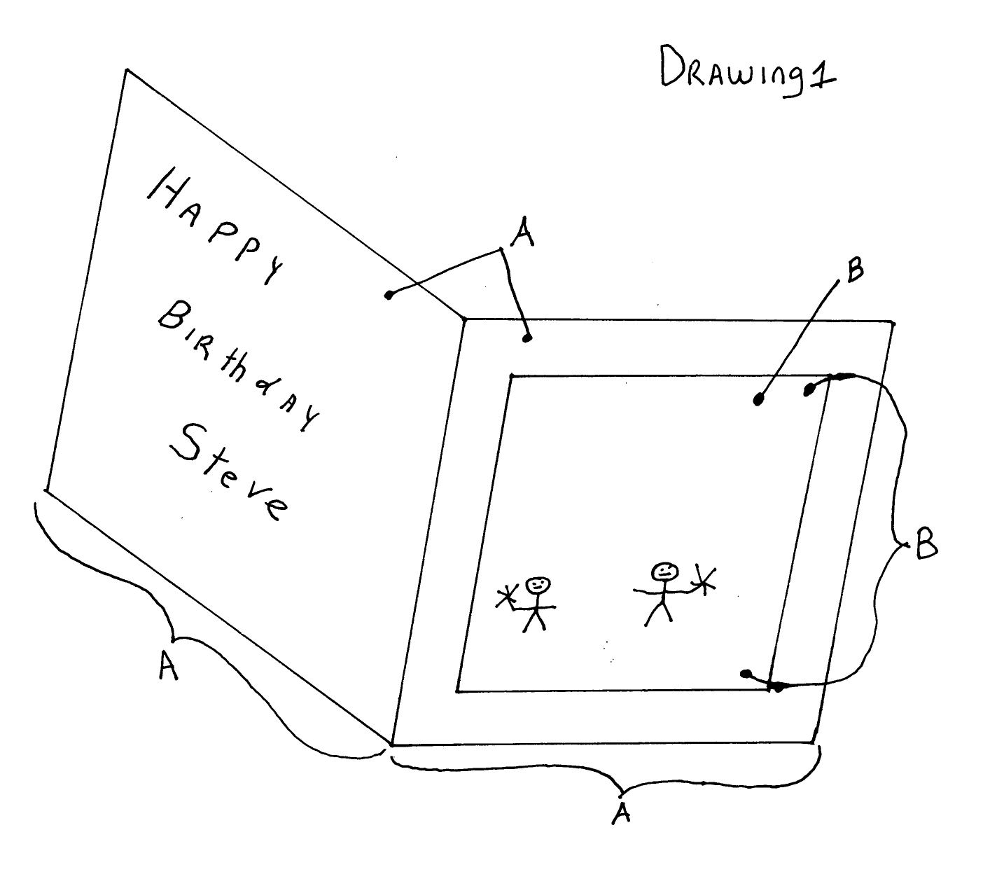

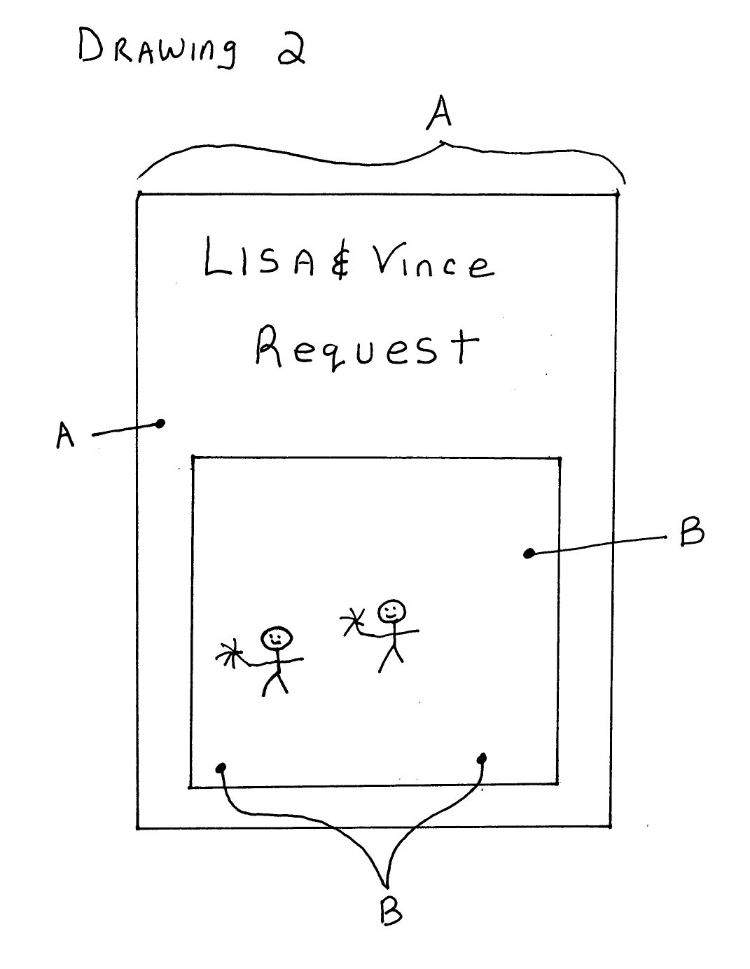

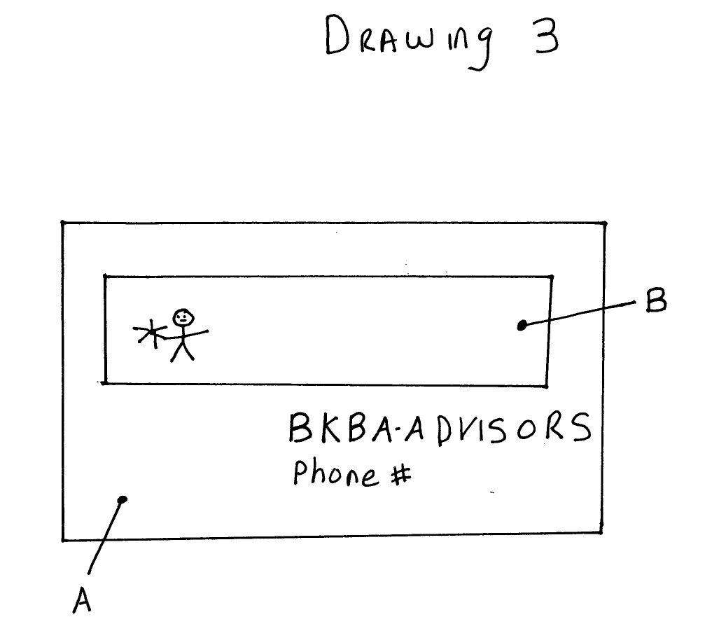

### BACKGROUND OF THE INVENTION

A greeting card is commonly an illustrated, folded or single page card featuring an expression of friendship or other sentiment. The custom of sending greeting cards is said to be traced back to the ancient Chinese, who exchanged messages of good will to celebrate the New Year. The early Egyptians are said to have conveyed their greetings on papyrus scrolls. People from Germany were known to have printed New Year's greetings from woodcuts as early as the year 1400. Also by the early 1400's, Valentines were being exchanged in various parts of Europe. By the 1850s, the greeting card had been transformed from a relatively expensive, handmade and hand-delivered gift to a popular and affordable means of personal communication—due largely to advances in printing and mechanization. This was followed by new trends like Christmas cards, the first of which is said to have appeared in published form in London around 1843. In the 1860s, companies began the mass production of greeting cards. Technical developments like color propelled the manufactured greeting card industry forward. Humorous greeting cards became popular in the late 1940s and 1950s.

Greeting Cards are given to celebrate almost every event in a person's life—such as birthdays, anniversaries, congratulations, just because, friendship, love & romance, thank you, graduation, invitational, promotions, religious holidays, sympathy and many more. Cards are, in short, a common and well-liked means of expressing an appropriate sentiment to a friend, relative or colleague on an important occasion. Recently, many new forms of greeting cards have been proposed and introduced.

There are photo greeting cards where a photo slides in just like a frame; greeting cards that play music; greeting cards that have movable parts or codes; greeting cards that have gifts or pre-paid greeting cards.

It is not always easy to find a mass produced card that expresses the right personal sentiment. U.S. Pat. No. 4,607,747 has a carton for gifts that includes an acoustic generator that is turned on when the carton is opened. U.S. Pat. No. 3,462,157 discloses an audible greeting card. U.S. Pat. No. 5,063,698 is a greeting card with electronic sound recording. U.S. Pat. No. 4,531,310 discloses a button or badge having a voice or sound synthesizer circuit. U.S. Pat. No. 7,236,258 has a basic personalized photo greeting card.

People have a desire to personalize their card that suits their personality. This is even more so today with the ability to down-load anything from the internet. The publics desire and capability to express themselves in a print and media form is on a collision course.

In accordance with progress, there is a need for a new, improved form of greeting card. Video is the technology of electronically capturing, recording, processing, storing, transmitting, and reconstructing a sequence of still images representing scenes in motion. Video technology was first developed for television systems, but has been further developed in many formats to allow for consumer video recording. Video can also be viewed through the Internet as video clips or streaming media clips on computer monitors.

The term video (from Latin: “I see”) commonly refers to storage formats for moving eye pictures. Some of these are: digital video formats, including DVD, QuickTime, and MPEG-4; and analog videotapes, including VHS and Betamax. Video can be recorded and transmitted in various physical media: in magnetic tape when recorded as PAL or NTSC electric signals by video cameras, or in MPEG-4 or DV digital media when recorded by digital cameras. A video player is a kind of media player for playing back digital video data from media such as optical discs, as well as from files of appropriate formats such as MPEG, AVI, Real Video, and QuickTime. In addition to VCR-like functions such as playing, pausing, stopping, rewinding, and forwarding, some common functions include zooming/full screen, audio channel selection, subtitle selection, and frame capturing. Many of the video players also support simple playback of digital audio.

A Media player is a term typically used to describe computer software for playing back multimedia files. Most software media players support an array of media formats, including both audio and video files.

A portable multimedia player (PMP), sometimes referred to as a portable video player (PVP), is a consumer electronics device that is capable of storing and playing digital media. Digital audio players (DAP) that can also display images and play videos are PMPs. Like DAPs, the data is typically stored on a hard drive, micro drive, or flash memory. Other types of electronic devices like cell phones are sometimes referred as PMPs due to their playback capabilities

Multimedia is media that utilizes a combination of different content forms.

The term is used in contrast to media which only utilize traditional forms of printed or hand-produced text and still graphics. In general, multimedia includes a combination of text, audio, still images, animation, video, wireless, and interactivity content forms. Multimedia is usually recorded and played, displayed or accessed by information content processing devices, such as computerized and electronic devices, but can also be part of a live performance. Multimedia (as an adjective) also describes electronic media devices used to store and experience multimedia content. Multimedia is similar to traditional mixed media in fine art, but with a broader scope. The term “rich media” is synonymous for interactive multimedia. Hypermedia can be considered one particular multimedia application.

Multimedia presentations may be viewed in person, on stage, projected, transmitted, or played locally with a media player. A broadcast may be a live or recorded multimedia presentation. Broadcasts and recordings can be either analog or digital electronic media technology. Digital online multimedia may be downloaded or streamed. Streaming multimedia may be live or on-demand.

Multimedia games and simulations may be used in a physical environment with special effects, with multiple users in an online network, or locally with an offline computer, game system, or simulator. The various formats of technological or digital multimedia may be intended to enhance the users experience, for example to make it easier and faster to convey information. Or in entertainment or art, to transcend everyday experience.

Enhanced levels of interactivity are made possible by combining multiple forms of media content. Online multimedia is increasingly becoming object-oriented and data-driven, enabling applications with collaborative end-user innovation and personalization on multiple forms of content over time. Examples of these range from multiple forms of content on web sites like photo galleries with both images (pictures) and title (text) user-updated, to simulations whose coefficients, events, illustrations, animations or videos are modifiable, allowing the multimedia “experience” to be altered without reprogramming. In addition to seeing and hearing, Haptic technology enables virtual objects to be felt. Emerging technology involving illusions of taste and smell may also enhance the multimedia experience.

The needs of the public, along with the emergence of existing and new technology, have driven the idea for this new, improved form of greeting card. This is the Video Greeting Card. As stated in the abstract, the Video Greeting Card is a Greeting Card that combines the existing form of a greeting card and incorporates the video/multi media player and screen. It is the next evolution in greeting cards.

### SUMMARY OF THE INVENTION

The abstract and background show with clarity the uniqueness of the new and improved Greeting Card. The Video Greeting Card is a combination of a traditional greeting card/invitation with modern multimedia technology (video/multimedia monitor/player screen). This is done by producing a card that includes/is attached to the video/multi media monitor/player screen itself. Pictures of the product, in addition to drawings, are included.

### BRIEF DESCRIPTION OF THE DRAWINGS

Drawing .1:

.a. Basic Traditional Opened Bi-Fold Greeting Card.

.b. Video/Multi Media Monitor player/Screen

Drawing .2.

.a. Single-Sheet Invitation Card

.b. Video/Multi Media Monitor player/Screen

Drawing .3.

.a. Business Card

.b. Video/Multi Media Monitor player/Screen

I claim:

1. A Greeting Card that has a video/multi-media player and monitor/screen attached to it.

2. A Greeting Card as stated in claim #1 that is in either the traditional folding card, single sheet paper as is produced for invitations and or a business card.

3. A Greeting Card as stated in claim #1, whereas the video/multi-media player and monitor/screen performs all functions of such devices, including down-loading data, uploading data, playing, pausing, replaying.
